(19) United States
(12) Patent Application Publication
(10) Pub. No.: US 2025/0092900 A1
(43) Pub. Date: Mar. 20, 2025

(54) Expanding Dowel Pin

(71) Applicant: Utah State University Space Dynamics Laboratory, North Logan, UT (US)

(72) Inventor: Gregory R. Hopkins, North Logan, UT (US)

(73) Assignee: Utah State University Space Dynamics Laboratory, North Logan, UT (US)

(21) Appl. No.: 18/370,507

(22) Filed: Sep. 20, 2023

(51) Int. Cl. F16B 13/12

(52) U.S. Cl. CPC F16B 13/124

(57) ABSTRACT

An expanding dowel-pin comprises an upper-collet, inside-conical bore with one or more upper-collet slits. The expanding dowel pin further includes a double-tapered cylinder with tapered cones tapering more narrowly from its middle. The expanding dowel pin further includes a lower collet with a lower-collet, inside-conical bore which has one or more lower-collet slits. The lower collet further includes a lower-collet, inside-straight bore with lower-collet internal screw threads. The upper collet, the double-tapered cylinder, and the lower collet are, in that order, configured to have a bolt pass therethrough. The lower-collet internal screw threads are configured to engage the bolt, such that, when the bolt is rotated a first direction relative to the lower collet, the upper collet and the lower collet are configured to be compressed together by the bolt. The compression by the bolt results in the expansion of the upper-collet and the lower-collet.

### TECHNICAL FIELD

The present disclosure relates to fasteners, and more particularly, to novel systems and methods for fastening objects together.

### BACKGROUND

Fasteners such as nails, screws, bolts, pins, etc., may be used to join objects together.

### SUMMARY

Applicant has identified the need for the precision fastening or joining of objects together. The objects may be plates or other objects with holes therein. The plates or objects and their respective holes may be misaligned or of varied sizes. There is a need to be able to fasten or join objects in a precise and secure manner. The present disclosure of various dowel-pin assemblies, in aspects and embodiments, addresses these various needs and problems.

In one embodiment, an expanding dowel pin comprises an upper collet that includes an upper-collet proximal end and an upper-collet distal end. The upper collet has an upper-collet, inside-conical bore that is tapered more narrowly towards the upper-collet proximal end. The upper-collet, inside-conical bore has one or more upper-collet slits extending along a length of the upper-collet, inside-conical bore.

The expanding dowel pin assembly further includes a double-tapered cylinder which has a double-tapered cylinder first end, a double-tapered cylinder second end, and a double-tapered cylinder middle positioned between the double-tapered cylinder first end and the double-tapered cylinder second end. The double-tapered cylinder further has a first tapered cone tapering more narrowly from the double-tapered cylinder middle towards the double-tapered cylinder first end and a second tapered cone tapering more narrowly from the double-tapered cylinder middle to the double-tapered cylinder second end.

The expanding dowel pin further includes a lower collet which has a lower-collet proximal end and a lower-collet distal end, and a lower-collet, inside-conical bore that is tapered more narrowly towards the lower-collet proximal end. The lower-collet, inside-conical bore has one or more lower-collet slits extending along a length of the lower-collet, inside-conical bore. The lower collet further includes a lower-collet, inside-straight bore with lower-collet internal screw threads. The lower-collet, inside-straight bore extends from the lower-collet, inside-conical bore to the lower-collet proximal end.

The upper collet, the double-tapered cylinder, and the lower collet are, in that order, configured to have a bolt pass therethrough.

The lower-collet internal screw threads are configured to engage the bolt, such that, when the bolt is rotated a first direction relative to the lower collet, the upper collet and the lower collet are configured to be compressed together by the bolt. The compression by the bolt results in the first tapered cone forcing the expansion of the upper-collet and the second tapered cone forcing the expansion of the lower-collet.

In embodiments, the expansion of the upper-collet is independent of the expansion of the lower-collet, meaning, the upper collet and the lower collet are able to expand to different sizes relative to each other. This feature can enable the expanding dowel-pin to engage different size holes that are also misaligned to one another.

In other embodiments, the first tapered cone forces the uniform expansion of the upper collet, meaning, the upper collet expands uniformly (e.g., at the same distance or rate) along the length of the upper-collet, inside-conical bore. Similarly, in embodiments, the second tapered cone forces the uniform expansion of the lower collet, meaning, the lower collet expands uniformly (e.g., at the same distance or rate) along the length of the lower-collet, inside conical bore. The uniform expansion of the upper collet or the lower collet provides better gripping or fastening force for the expanding dowel-pin to fasten or join objects in a precise and secure manner.

Also, in embodiments, the double-tapered cylinder is configured such that compression by the bolt of the upper collet towards the lower collet does not deform the double-tapered cylinder and the double-tapered cylinder does not bind the bolt.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIGS. 1A through 1E illustrate plates joined together by two bolts;

FIGS. 2A through 2E illustrate two plates and their respective holes or slots with different positions and sizes;

FIG. 3 illustrates an exploded view of an expanding dowel-pin;

FIGS. 4A through 4D illustrate various views of an upper collet;

FIGS. 5A through 5C illustrate various views of a double-tapered cylinder;

FIGS. 6A through 6D illustrate various views of a lower collet;

FIGS. 7A through 7C illustrate various views of the expanding dowel-pin shown in FIG. 3, as well as a bolt and a washer;

FIG. 8 illustrates an upper collet;

FIG. 9 illustrates a lower collet;

FIG. 10A illustrates an assembled dowel-pin and FIG. 10B illustrates a cut-away view of the assembled dowel-pin of FIG. 10A;

FIGS. 11A and 11B illustrate two views of an assembled dowel-pin inserted into two plates;

FIGS. 12A through 12H illustrate various views of different upper-collet embodiments;

FIGS. 13A through 13E illustrate various views of a lower collet embodiment;

FIGS. 14A through 14C illustrate various views of another dowel-pin embodiment as well as a bolt, a washer, and a washer with flat sides;

FIGS. 15A through 15D illustrate various views of another double-tapered cylinder embodiment;

FIGS. 16A through 16C illustrate various views of another dowel-pin embodiment as well as a bolt, a washer, and a washer with flat sides;

FIGS. 17A through 17D illustrate various views of another double-tapered cylinder embodiment;

FIGS. 18A through 18E illustrate various views of another upper collet embodiment;

FIGS. 19A, 19B, and 19C illustrate various views of another dowel-pin embodiment as well as a bolt, washer, and a washer with flat sides;

FIGS. 20A, 20B, and 20C illustrate various views of another assembled dowel-pin embodiment;

FIG. 21 illustrates another upper collet embodiment;

FIG. 22 illustrates another lower collet embodiment;

FIGS. 23A, 23B, and 23C illustrate various views of another dowel-pin embodiment as well as a bolt, a washer, and a washer with flat sides;

FIGS. 24A through 24E illustrate various views of another dowel-pin embodiment as well as a bolt, a washer, and a washer with flat sides;

FIG. 25A illustrates a top view of two plates and FIG. 25B illustrates another top view of the two plates fastened together with embodiments of an expanding dowel pin;

FIG. 26A illustrates a top view of two plates and FIG. 26B illustrates another top view of the two plates fastened together with embodiments of an expanding dowel pin;

FIGS. 27A, 27B, and 27C illustrate various views of a chevron-shaped cylinder;

FIG. 28 illustrates an exploded view of another expanding dowel-pin embodiment as well as a bolt, a washer, and a washer with flat sides;

FIGS. 29A through 29C illustrate various views of another expanding dowel-pin embodiment as well as a bolt, a washer, and a washer with flat sides; and

FIG. 30 illustrates a method for providing an expanding dowel pin.

### DETAILED DESCRIPTION

The present disclosure covers apparatuses and associated methods for using an expanding dowel pin. In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as illustrated in some aspects in the drawings, is not intended to limit the scope of the invention, but is merely representative of the various embodiments.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive or mutually inclusive, unless expressly specified otherwise.

In this specification and the claims that follow, singular forms such as “a,” “an,” and “the” include plural forms unless the content clearly dictates otherwise. All ranges disclosed herein include, unless specifically indicated, all endpoints and intermediate values. In addition, “optional,” “optionally,” or “or” refer, for example, to instances in which subsequently described circumstance may or may not occur and include instances in which the circumstance occurs and instances in which the circumstance does not occur. The terms “one or more” and “at least one” refer, for example, to instances in which one of the subsequently described circumstances occurs, and to instances in which more than one of the subsequently described circumstances occurs.

In addition, terms such as “upper” or “lower” refer, for example, to the positions of parts relative to other parts or as a means of differentiating or describing one part from another. In practice, however, a part that is “upper” may actually be positioned “lower” to another part, depending on the orientation of the assembly in which both “upper” and “lower” parts are assembled.

Similarly, terms such as “proximal” or “distal” refer to the positions of parts or portions of parts relative to other parts or other portions of parts as a means of differentiating or describing one part or portions of a part from another. A part or a portion of a part that is “distal” might actually be “proximal” depending on the position of the observer.

In this disclosure, “uniform” means equal or near equal. For example, “uniform expansion” means the equal or near equal expansion of a part across its length. Likewise, “uniform force” refers to the equal or near equal force applied by various components against other components across their interfacing area as they are pressed together. By way of illustration, in other applications, but using the same definition of the term “uniform,” gravity exerts a “uniform” downward force on an object across its entire length or width (or area) as a function of the object's density. Likewise, an object submersed in a fluid experiences a “uniform” pressure or force against all of its surface area exposed to the fluid as a function of the amount of fluid pressing on the submersed object.

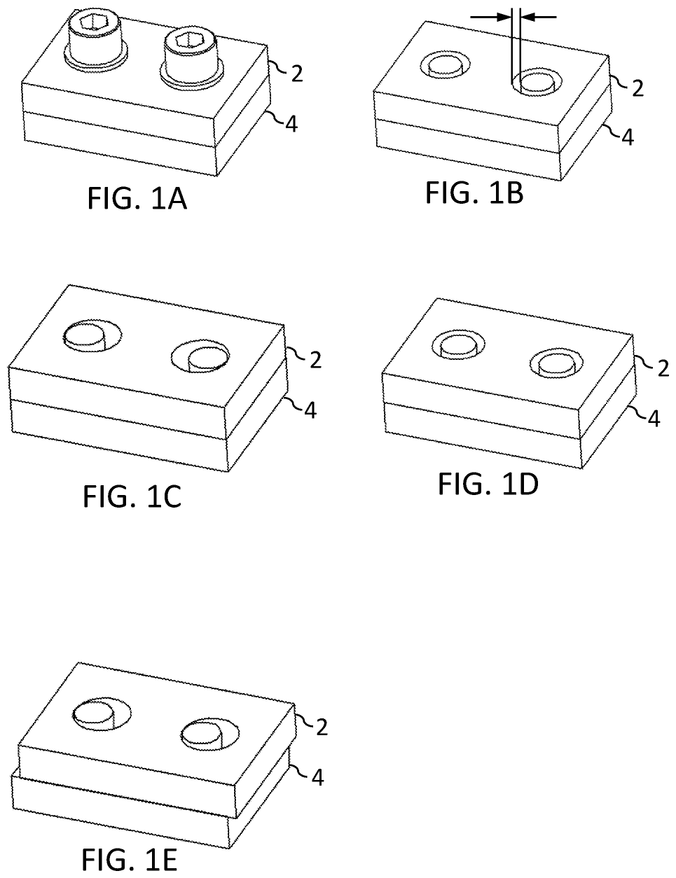

FIGS. 1A through 1E illustrate plate 2 connected to plate 4 with two bolts. In FIGS. 1B through 1E, the screw heads and washers have been removed for better visualization. In FIG. 1B, the plate 2 and plate 4 are (theoretically) perfectly aligned, as are the holes through which the bolts pass and the (exaggerated) distance between the bolt shafts and the hole sides are the same for both plates 2 and 4. In FIG. 1C, the hole positions are shifted relative to the bolts. In FIG. 1D, the hole sizes are reduced. In FIG. 1E the plates are shifted.

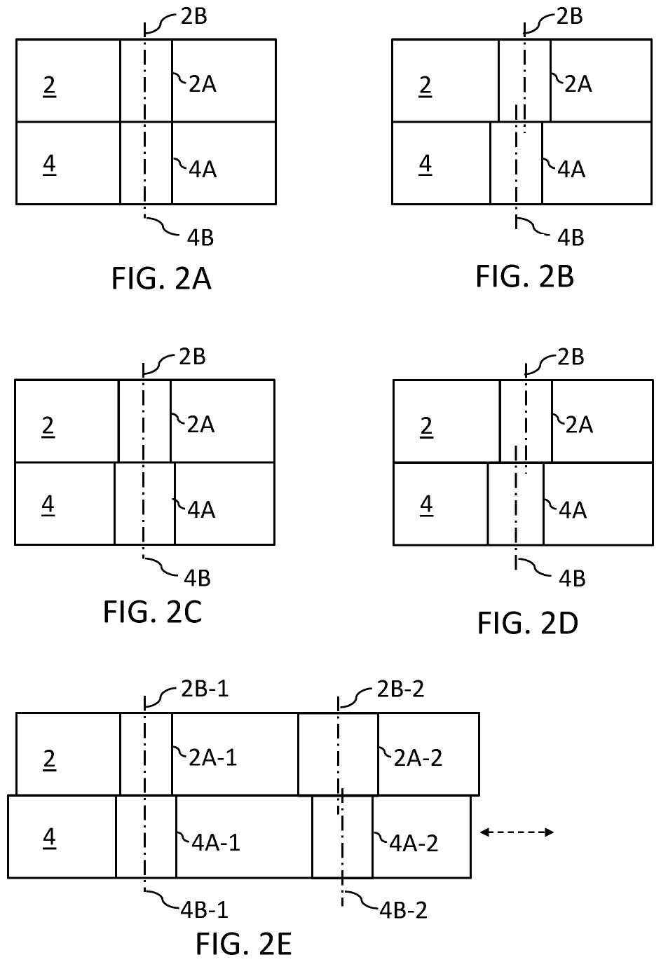

FIGS. 2A through 2E illustrate plates 2 and 4 and their respective holes 2A and 4A in various positions and sizes relative to each other. In FIG. 2A, the plates 2 and 4 and the holes 2A and 4A are perfectly aligned, as shown by the centerline 2B or hole 2A being perfectly aligned with centerline 4B of hole 4A. In practice, however, the holes 2A and 4A may be misaligned (as shown in FIG. 2B), the holes 2A and 4A may be different sizes (as shown in FIG. 2C), and the holes 2A and 4A may be misaligned and different sizes (as shown in FIG. 2D).

FIG. 2E illustrates plates 2 and 4 with holes 2A-1 and 4A-1, which have different size diameters from each other. In addition, slot 2A-2 and hole 4A-2 have centerlines 2B-2 and 4B-2, respectively, that are not aligned.

The applicant of the present disclosure has identified the need to provide a fastener that is able to attach, for example, plates 2 and 4, which may or may not have different size holes that are or are not misaligned. This may be done in a manner that not only secures the plates 2 and 4 together but is also able, depending on the embodiment, to align the plates 2 and 4 or account for differences in the sizes or locations of holes in the respective plates.

The following example embodiments may be used to address these issues are illustrative only and are not intended to limit the disclosure in any way.

### EXAMPLES

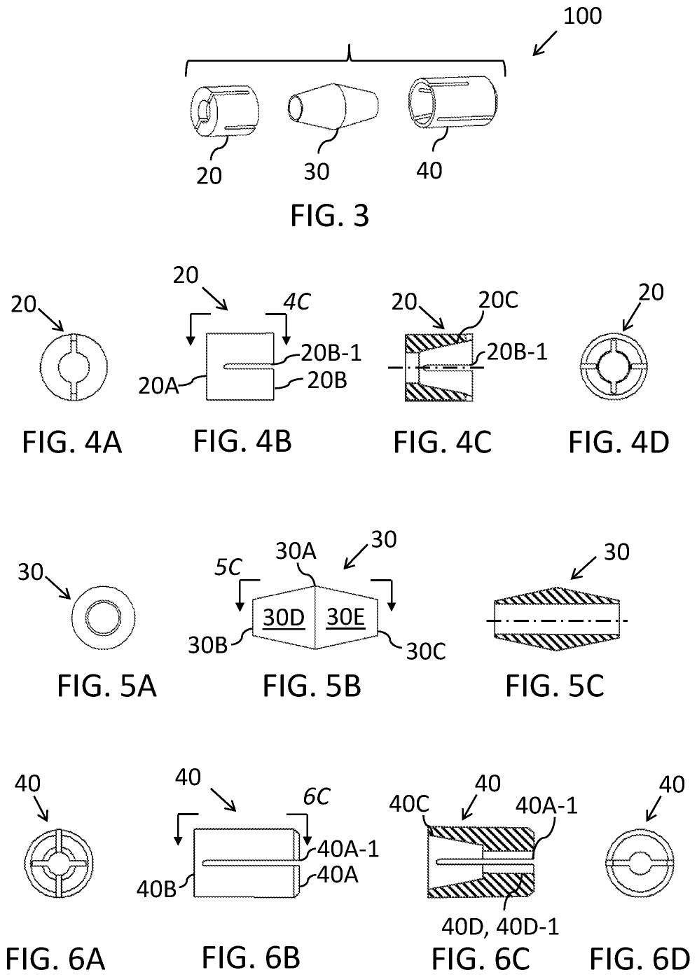

FIG. 3 illustrates an exploded view of an expanding dowel-pin 100. In this embodiment, the expanding dowel pin 100 includes an upper collet 20, a double-tapered cylinder 30, and a lower-collet 40. The exploded view of expanding dowel-pin 100 in FIG. 3 further illustrates the relative position of the parts of the expanding dowel-pin 100 relative to each other.

FIGS. 4A through 4D illustrate various views of the upper collet 20. FIGS. 4A and 4D are end-views of upper collet 20. FIG. 4B is a side view of upper collet 20. FIG. 4C is a cross-sectional view from FIG. 4B. The upper collet 20 has an upper-collet proximal end 20A and an upper-collet distal end 20B. The upper collet 20 further includes an upper-collet, inside-conical bore 20C that is tapered more narrowly towards the upper-collet proximal end 20A. The upper-collet, inside-conical bore 20C has one or more upper-collet slits 20B-1 extending along a length of the upper-collet, inside conical bore 20C.

FIGS. 5A, 5B, and 5C illustrate various views of the double-tapered cylinder 30. FIG. 5A is an end-view, FIG. 5B is a side view, and FIG. 5C is a cross-sectional view of double-tapered cylinder 30. Double-tapered cylinder 30 has a double-tapered cylinder first end 30B, a double-tapered cylinder second end 30C, and a double-tapered cylinder middle 30A positioned between the double-tapered cylinder first end 30B and the double-tapered cylinder second end 30C. In this embodiment, double-tapered cylinder 30 is symmetrical, meaning, double-tapered cylinder first end 30B and the double-tapered cylinder second end 30C are mirror images of each other. However, in other embodiments, double-tapered cylinder first end 30B and the double-tapered cylinder second end 30C may have different slopes, lengths, or shapes.

The double-tapered cylinder 30 has a first tapered cone 30D tapering more narrowly from the double-tapered cylinder middle 30A towards the double-tapered cylinder first end 30B and a second tapered cone 30E tapering more narrowly from the double-tapered cylinder middle 30A to the double-tapered cylinder second end 30C.

FIGS. 6A through 6D illustrate various views of lower collet 40. FIGS. 6A and 6D illustrate end views, FIG. 6B illustrates a side view, and FIG. 6C illustrates a sectional view from FIG. 6B of lower collet 40.

A lower collet 40 has a lower-collet proximal end 40A and a lower-collet distal end 40B. In addition, lower collet 40 has a lower-collet, inside-conical bore 40C that is tapered more narrowly towards the lower-collet proximal end 40A. The lower-collet, inside-conical bore 40C also has one or more lower-collet slits 40A-1 extending along a length of the lower-collet, inside-conical bore 40C. Lower collet 40 also has a lower-collet, inside-straight bore 40D with lower-collet internal screw threads 40D-1. The lower-collet, inside-straight bore 40D extends from the lower-collet, inside-conical bore 40C to the lower-collet proximal end 40A.

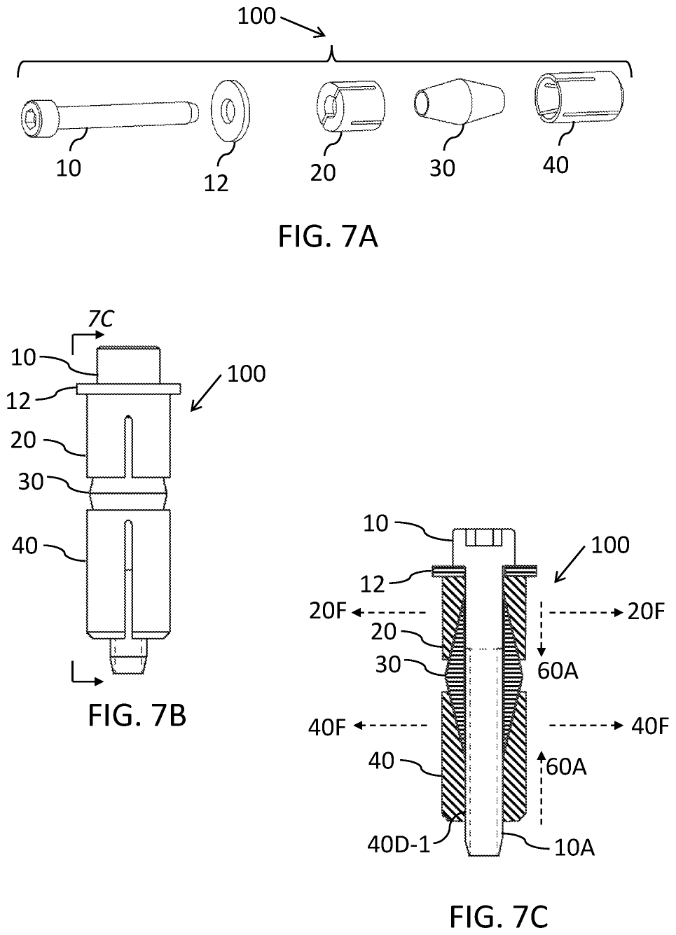

FIGS. 7A, 7B, and 7C illustrate various views of expanding dowel-pin 100, in addition to a bolt or machine screw 10 and a washer 12. FIG. 7A illustrates an exploded view of expanding dowel-pin 100, including the orientation of its parts relative to each other. FIG. 7B illustrates an assembled dowel-pin 100 with the bolt 10 passing through the washer 12 and then through the dowel-pin 100. FIG. 7C illustrates a cross-sectional view of dowel-pin 100. In FIG. 7C, hash marks, typically shown in cross-sectional views, are not shown in relation to the bolt 10 so as to show a possible location of the bolt or machine-screw threads 10A relative to the lower-collet, internal screw threads 40D-1.

Expanding dowel-pin 100 has the upper collet 20, the double-tapered cylinder 30, and the lower collet 40, configured, in that order, to have a bolt 10 pass therethrough. In addition, the lower-collet internal screw threads 40D-1 are configured to engage the bolt 10, such that, when the bolt 10 is rotated a first direction (e.g., clockwise) relative to the lower collet 40, the upper collet 20 and the lower collet 40 are configured to be compressed together by the bolt 10, resulting in the first tapered cone 30D forcing the expansion of the upper-collet 20 and the second tapered cone 30E forcing the expansion of the lower-collet 40.

In embodiments, the expansion of the upper-collet is independent of the expansion of the lower-collet, meaning, the upper collet and the lower collet are able to expand to different sizes relative to each other. This feature can enable the expanding dowel-pin to engage different sized holes that are also misaligned to one another. In other embodiments, the first tapered cone forces the uniform expansion of the upper collet, meaning, the upper collet expands uniformly (e.g., at the same distance or rate) along the length of the upper-collet, inside-conical bore. Similarly, in embodiments, the second tapered cone forces the uniform expansion of the lower collet, meaning, the lower collet expands uniformly (e.g., at the same distance or rate) along the length of the lower-collet, inside conical bore. The uniform expansion of the upper collet or the lower collet provides better gripping or fastening force for the expanding dowel-pin to fasten or join objects in a precise and secure manner.

In embodiments, the expansion of the upper-collet 20 may be independent of the expansion of the lower-collet 40. This feature may allow the upper collet 20 to engage a hole that is a different size and has a different centerline than a hole engaged by the lower collet 40.

Also, in embodiments, the double-tapered cylinder 30 is configured such that compression by the bolt 10 of the upper collet 20 towards the lower collet 40 does not deform the double-tapered cylinder 30 and the double-tapered cylinder 30 does not bind the bolt 10. In this sense, the double-tapered cylinder 30 is not a ferrule, which is typically used to bind, as a means of fastening, joining, sealing, or reinforcing, whatever the ferrule is surrounding.

So as not to deform from the compression of the upper collet 20 towards the lower collet 40, the double-tapered cylinder 30 should be made of a harder material such as steel. Other materials such as brass, copper, or plastic might cause the double-tapered cylinder 30 to otherwise compress and bind the bolt 10 when the bolt 10 is rotated relative to the lower collet 40. Compression or deformation of the double-tapered cylinder 30 around the bolt 10 could make removal of an expanding dowel-pin 100 from a hole (such as holes 2A and 4A) more difficult.

FIG. 7C further illustrates various forces 20F and 40F and the bolt or machine screw compressive force 60A that are created when the dowel-pin is inserted and assembled within a hole (shown in other figures). As described above, as the bolt 10 is rotated a first direction (e.g., clockwise) relative to the lower collet 40, the upper collet 20 and the lower collet 40 are configured to be compressed together by the bolt 10 (with bolt compressive force 60A). Also, the first tapered cone 30D (shown in FIG. 5B) forces the expansion of the upper-collet 20, resulting in an upper-collet expansion force 20F. Similarly, the second tapered cone 30E (also shown in FIG. 5B) forces the expansion of the lower-collet 40, resulting in a lower-collet expansion force 40F.

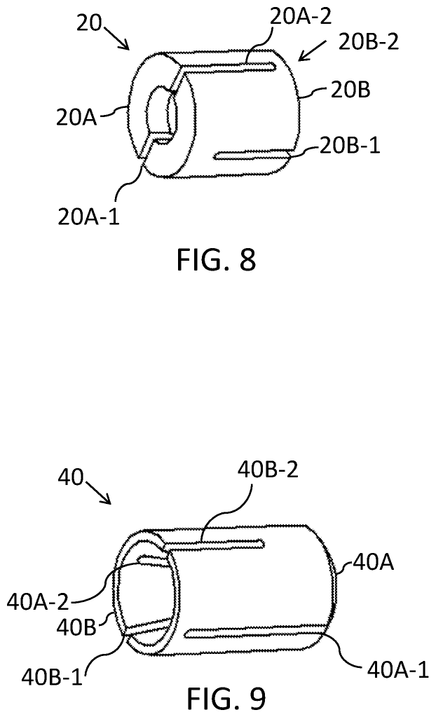

FIGS. 8, 9, 10A, 10B, 11A, and 11B, illustrate various parts and views of an expanding dowel-pin 100. FIGS. 8 and 9 illustrate specific features of upper collet 20 and lower collet 40, respectively. In this embodiment, the one or more upper-collet slits 20A-1, 20A-2, 20B-1, etc., are four upper-collet slits: two, upper-collet, distal-end slits 20B-1 and 20B-2 that extend from the upper-collet distal end 20B, and two upper-collet, proximal-end slits 20A-1 and 20A-2 that both extend from the upper-collet proximal end 20A. In this embodiment, each of the two upper-collet, distal-end slits 20B-1 and 20B-2 are positioned 90-degrees radially of one of the two upper-collet, distal-end slits 20A-1 or 20A-2. The position of upper-collet, distal-end slit 20B-2 is not shown in FIG. 8 as it is on the opposite side of upper collet 20 (in the isometric view of FIG. 8). Similarly, the one or more lower-collet slits 40A-1, 40A-2, 40B-1, and 40B-2, are four lower-collet slits: two, lower-collet, distal-end slits 40B-1 and 40B-2 that extend from the lower-collet distal end 40B and two, lower-collet, proximal-end slits 40A-1 and 40A-2 that extend from the lower-collet proximal end 40A. Each of the two, lower-collet distal-end slits 40B-1 and 40B-2 are positioned 90-degrees radially of one of the two, lower-collet, distal-end slits 40A-1 or 40A-2.

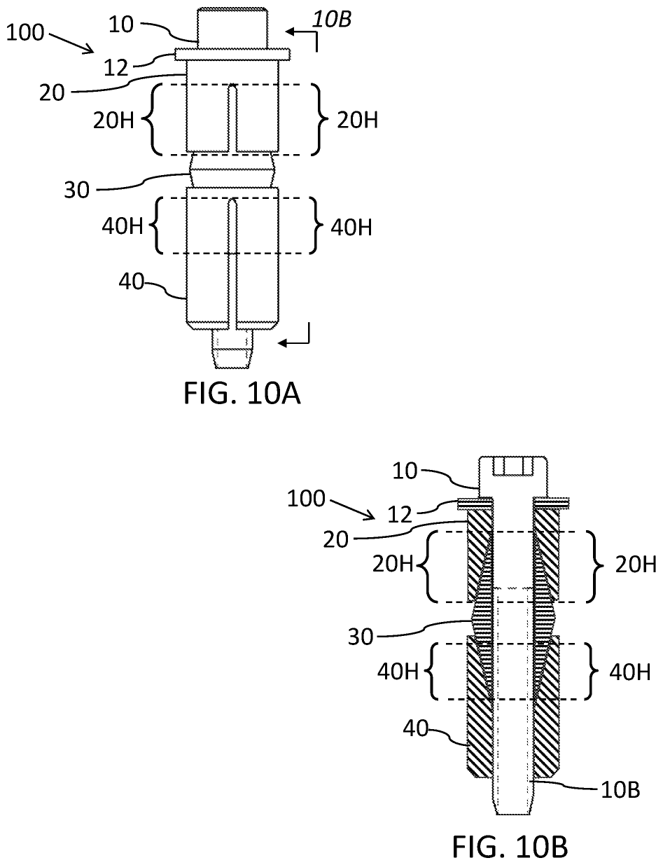

In this embodiment, the upper-collet inside conical bore 20C (shown in FIG. 4C) is configured to interface with the first tapered cone 30D (shown in FIG. 5B), making an upper-collet, double-tapered cylinder interface 20H, shown in FIGS. 10A and 10B. Similarly, the lower-collet inside conical bore 40C (shown in FIG. 6C) is configured to interface with the second tapered cone 30E (shown in FIG. 5B), making a lower-collet, double-tapered cylinder interface 40H.

FIG. 10B is a cut-away view of FIG. 10A. For clarity, the bolt 10 in FIG. 10B is not shown as being cut as cross-hatching is not used to illustrate the cut-away view. Instead, bolt threads 10B are illustrated as dashed lines. As in FIG. 10B, cross hatching is not used in various other cut-aways views to better illustrate the bolt 10 in relation to the other parts.

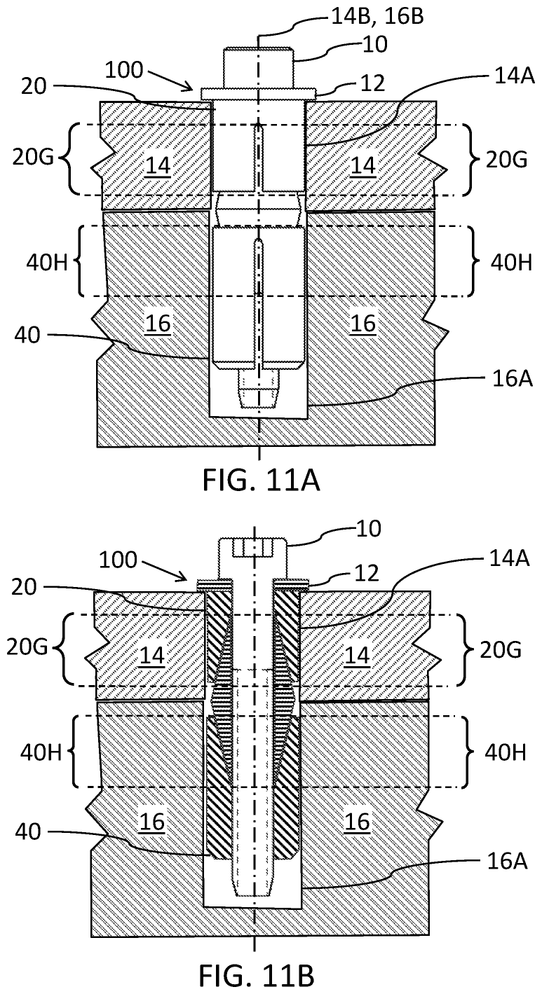

FIGS. 11A and 11B illustrate the expanding dowel-pin 100 assembled in an upper plate 14 and a lower plate 16. Referring back to FIGS. 7C, 8, and 10A, the upper-collet, double-tapered cylinder interface 20H and the four upper-collet slits 20A-1, 20A-2, 20B-1, and 20B-2 are configured, in response to the bolt 10 compressing the upper collet 20 towards the lower collet 40, to create an upper-collet expansion force 20F at the upper-collet, double-tapered cylinder interface 20G. Likewise, the lower-collet, double-tapered cylinder interface 40H and the four lower-collet slits 40A-1, 40A-2, 40B-1, and 40B-2 are configured, in response to the bolt 10 compressing the upper collet 20 towards the lower collet 40, to create a lower-collet expansion force 40F at the lower-collet, double-tapered cylinder interface 40H.

The upper-collet expansion force 20F may be uniform along the length of the four upper-collet slits 20A-1, 20A-2, 20B-1, and 20B-2 such that the upper-collet expansion force 20F is a uniform force against the inside diameter of a hole, for example, the hole 14A (shown in FIGS. 11A and 11B). Similarly, the lower-collet expansion force 40F may be uniform along the length of the four lower-collet slits 40A-1, 40A-2, 40B-1, and 40B-2 such that the lower-collet expansion force 40F is a uniform force against the inside diameter of a hole, for example, the hole 16A (shown in FIGS. 11A and 11B).

In this embodiment, the upper-collet expansion force 20F and the lower-collet expansion force 40F may each be uniform across the upper-collet, double-tapered cylinder interface 20H or the lower-collet, double-tapered cylinder interface 40H, respectively.

In this embodiment, the uniformity of the force 20F is a result of the equal or near-equal (e.g., uniform) surface contact between the upper collet 20 and the double-tapered cylinder 30 at the upper-collet, double-tapered cylinder interface 20H. Likewise, the uniformity of the force 40F is a result of the equal or near-equal (e.g., uniform) surface contact between the lower collet 40 and the double-tapered cylinder 30 at the lower-collet, double-tapered cylinder interface 40H.

The uniform surface contact at the upper-collet, double-tapered cylinder interface 20H is thought to create an upper-collet expansion force 20F at the upper-collet, double-tapered cylinder interface 20G that is uniform along the length of the four upper-collet slits 20A-1, 20A-2, 20B-1, and 20B-2. Similarly, the uniform surface contact at the lower-collet, double-tapered cylinder interface 40H is thought to create a lower-collet expansion force 40F at the lower-collet, double-tapered cylinder interface 40G that is uniform along the length of the four lower-collet slits 40A-1, 40A-2, 40B-1, and 40B-2. A uniform forces provides better gripping or fastening force for the expanding dowel-pin 100 to fasten or join objects in a precise and secure manner.

Referring again to FIGS. 11A and 11B, in an embodiment, the expanding dowel-pin 100 is configured to be placed into a hole 14A formed within an upper plate 14, being an upper-plate hole 14A, then through or into a hole 16A formed within a lower plate 16, being a lower-plate hole 16A. In embodiments, the upper-collet expansion force 20F (illustrated in FIG. 7C) together with the lower-collet expansion force 40F (also illustrated in FIG. 7C) creates an expanding dowel-pin 100 concentric-alignment force that forces concentric alignment between the upper-plate hole 14A and the lower-plate hole 16A. For example, as illustrated in FIG. 11A, the upper-plate hole centerline 14B and lower-plate hole centerline 16B are forced to be concentric with each other due to the expanding dowel-pin 100 concentric-alignment force.

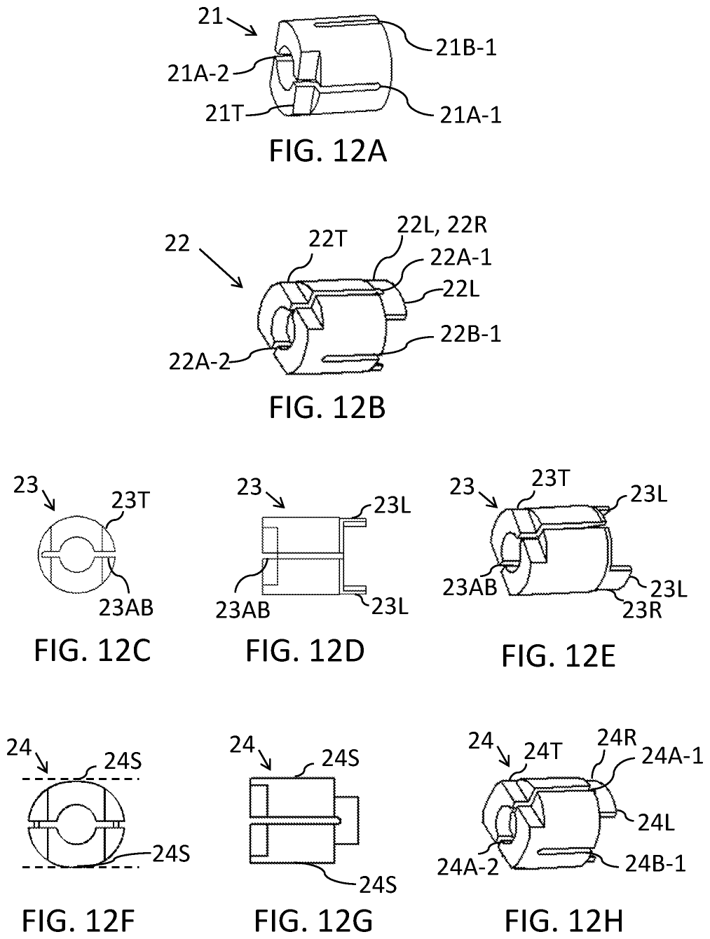

FIGS. 12A through 12H illustrate several embodiments of upper collets 21, 22, 23, and 24. In embodiments, the upper collet further includes upper-collet torsional captive flats 21T, 22T, 23T or 24T. In embodiments, the upper collet is configured to be held, by the upper-collet torsional captive flats 21T, 22T, 23T or 24T, from rotating relative to the bolt 10 when the bolt 10 is rotated the first direction relative to the lower collet 40.

An upper collet may further include an upper-collet torsional locking feature 22L, 23L, or 24L; a relief 22R, 23R, or 24R; slits 21A-1, 21A-2, 21B-1, 21B-2, 22A-1, 22A-2, 22B-1, 22B-2, 23AB, 24A-1, 24A-2, 24B-1, 24B-2 etc., or upper-collet flats 24S.

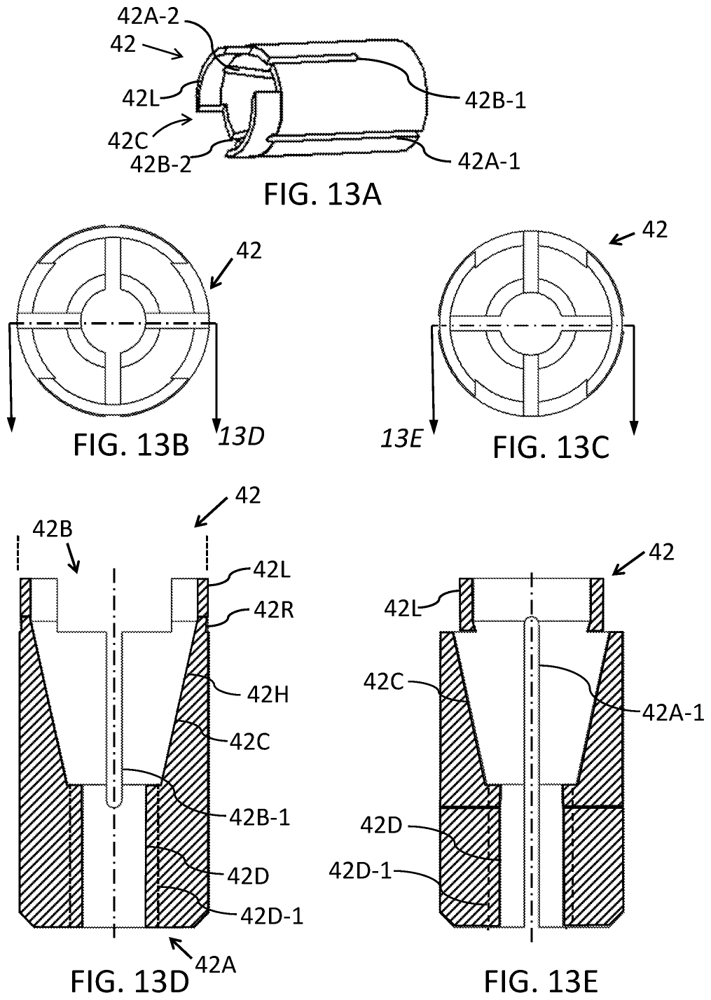

FIGS. 13A through 13E illustrate various possible features of lower collet 42. Lower collet 42 may include a lower-collet proximal end 42A, lower-collet proximal-end slits 42A-1 and 42A-2, a lower-collet distal end 42B, lower-collet distal-end slits 42B-1 and 42B-2, a lower-collet inside conical bore 42C, a lower-collet straight bore 42D, lower-collet internal screw threads 42D-1, a lower-collet double-tapered cylinder interface 42H, and a lower-collet relief 42R.

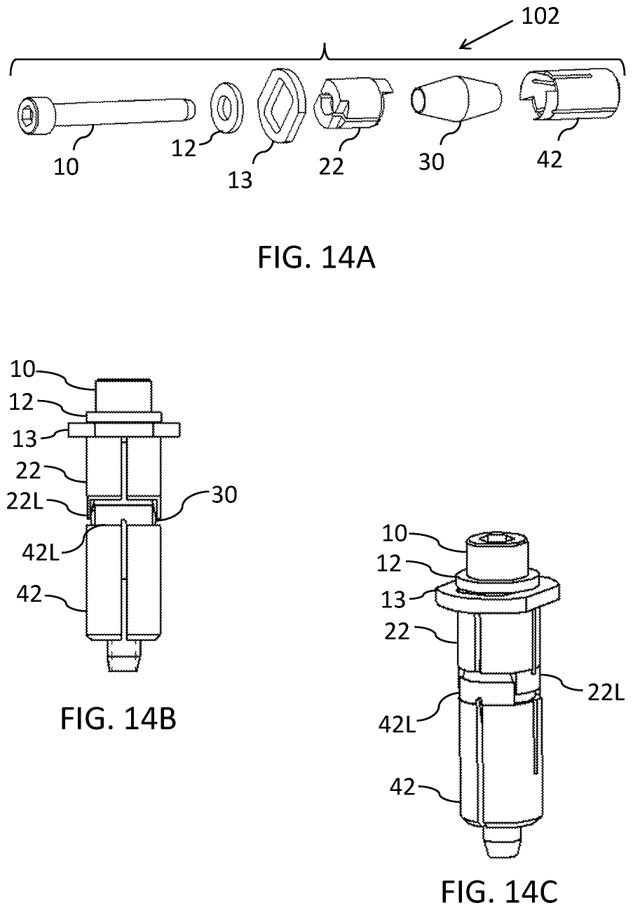

The lower collet 42 further comprises a lower-collet torsional locking feature 42L. As described above, when the bolt 10 is rotated the first direction relative to the lower collet 42, the upper-collet torsional captive flats 22T, 23T, or 24T are configured to be held from rotating relative to the bolt 10. Also, as shown in FIGS. 14B and 14C, the upper-collet torsional locking feature 22L, 23L, or 24L (only upper-collet torsional locking feature 22L is shown in FIGS. 14B and 14C) is configured to interface with and prevent rotation of the lower-collet torsional locking feature 42L and thus rotation of the lower collet 42 relative to the bolt 10.

FIGS. 14A through 14C illustrate various views of expanding dowel-pin 102, in addition to a bolt or machine screw 10, a washer 12, and a washer 13 (which has captive flats on its sides). FIG. 14A illustrates an exploded view of expanding dowel-pin 102, including the orientation of its parts relative to each other. FIG. 14B illustrates an assembled dowel pin 102 with the bolt 10 passing through the washers 12 and 13, and then through the dowel-pin 102. FIG. 14C illustrates an isometric view of dowel pin 102. FIGS. 14B and 14C illustrate the relative positions of the upper-collet torsional locking feature 22L to the lower-collet torsional locking feature 42L.

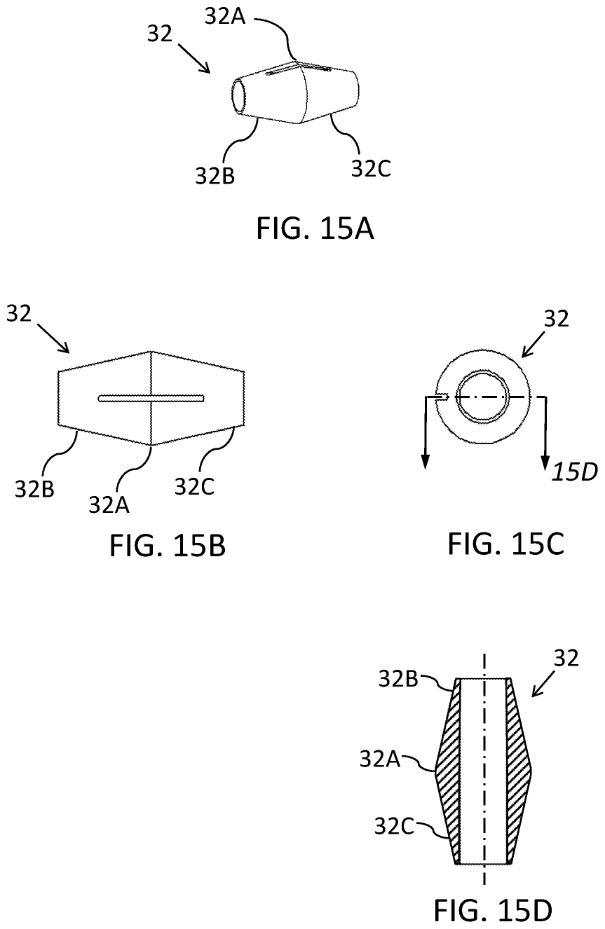

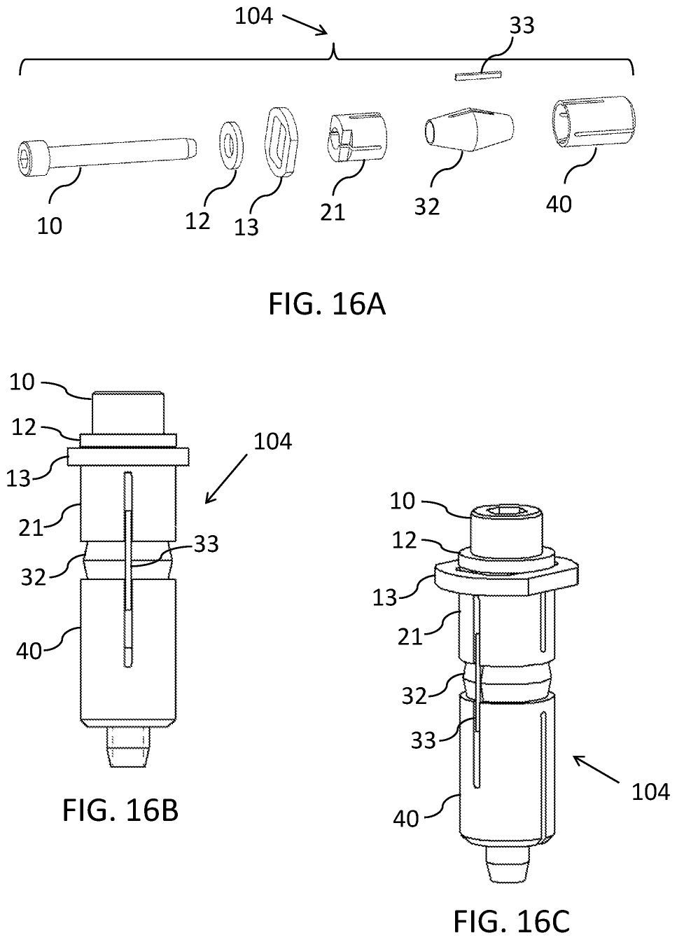

Referring now to FIGS. 15-15D and 16A-16C, in embodiments, an expanding dowel pin 104 further comprises a torsional locking key 33 configured to extend from the upper collet 21 to the lower collet 40 and interface with both the upper collet 21 and the lower collet 40 such that a rotation of the upper collet 21 is locked to a rotation of the lower collet 40. To accommodate the torsional locking key 33, a double-tapered cylinder key slot 32A (shown in FIGS. 15, 15B, and 15C) may be cut or formed into the double-tapered cylinder 32. Additionally, or alternatively, the one or more slits in upper collet 21 and lower collet 40, used to allow the expansion of upper collet 21 and lower collet 40, respectively, may be configured to have a simultaneous function of receiving the torsional locking key 33.

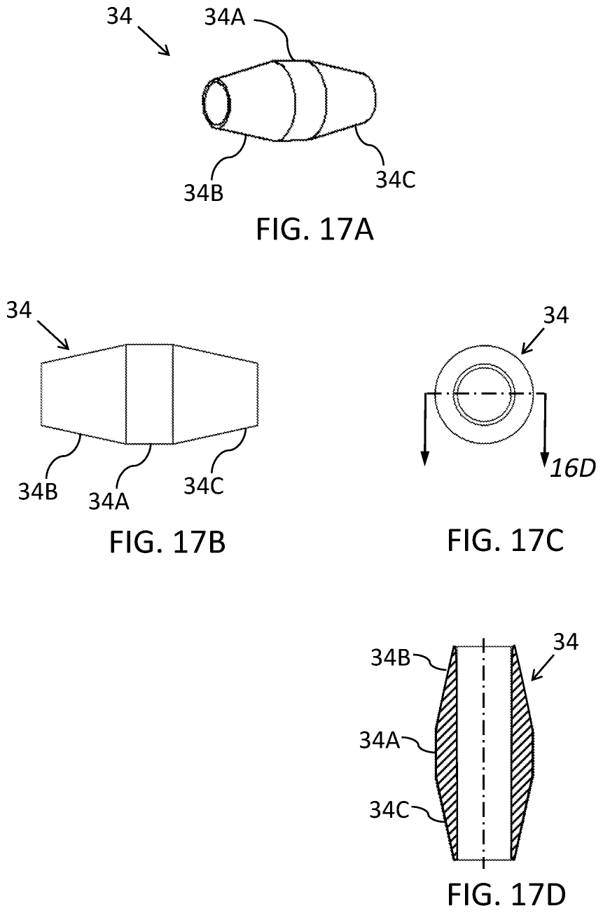

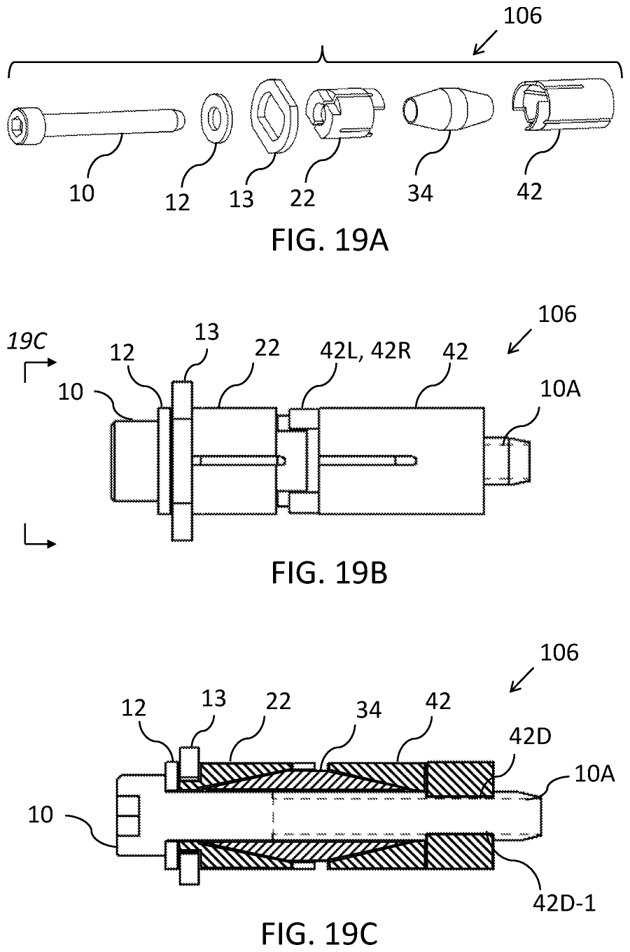

Referring now to FIGS. 17A through 17D, in another embodiment, a double-tapered cylinder 34 further comprises a straight cylinder 34A positioned between the first tapered cone 34B and the second tapered cone 34C. In application, the straight cylinder 34A extends the length of the double-tapered cylinder 34 allowing the expanding dowel pin (e.g., expanding dowel pin 106 shown in FIGS. 19A through 19C) to be used in broader applications that require a longer expanding dowel pin.

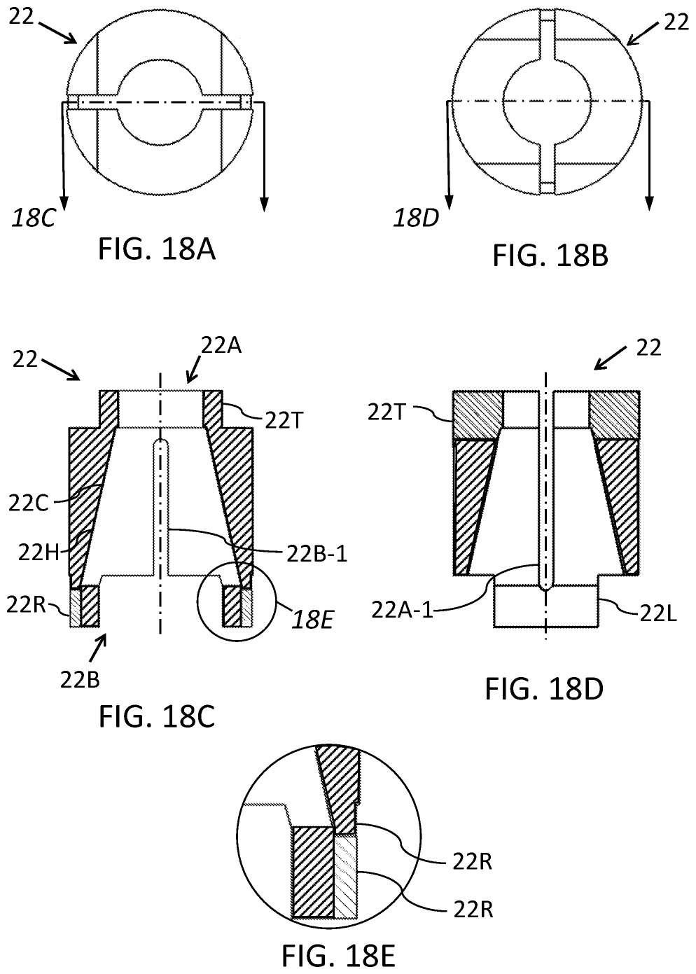

FIGS. 18A through 18E illustrate various possible features of an upper collet 22. Upper collet 22 includes upper-collet proximal end 22A; upper-collet proximal-end slit 22A-1; upper-collet distal end 22B; upper-collet distal-end slit 22B-1; upper-collet inside conical bore 22C; upper-collet, double-tapered cylinder interface 22H; upper-collet torsional locking feature 22L; and upper-collet torsional captive flats 22T. Upper collet 22 also includes an upper-collet relief 22R, shown in greater detail in FIG. 18E. Upper-collet relief 22R is a reduction in the outside diameter of the upper collet 22 starting at the upper-collet locking tabs 22L and extending some distance from the upper-collet distal end 22B.

In some embodiments, a lower collet, such as lower collet 42 with lower-collet torsional locking features 42L, also has a lower-collet relief 42R (shown in FIG. 13D).

In some applications, the upper-collet torsional locking feature 22L, 23L, or 24L (shown, for example, in FIGS. 12B, 12E, and 12H, respectively) is configured to interface with and prevent rotation of the lower-collet torsional locking feature 42L (shown FIG. 13D) and thus rotation of the lower collet 42, relative to the bolt 10. When the expanding dowel pin 102 or 106 is assembled, the upper-collet torsional locking feature 22L overlaps with the lower-collet torsional locking feature 42L. When an expanding dowel pin is installed, the overlap between upper-collet torsional locking feature 22L and lower-collet torsional locking feature 42L means that upper-collet torsional locking feature 22L extends into the hole 4A (shown in FIGS. 2A through 2D). Also, lower-collet torsional locking feature 42L extends into the hole 2A (also shown in FIGS. 2A through 2D).

Holes 2A and 4A may be misaligned (FIGS. 2B and 2C) or may have different diameters (FIGS. 2C and 2D). Upper-collet relief 22R or 24R (detailed in FIG. 18E), allows the expansion of the upper collet 22 or 24 into the size or diameter of the hole, such as upper-plate hole 2A (shown in FIGS. 2A through 2D) or upper-plate holes 2A-1 or 2A-2 (shown in FIG. 2E) without having the upper-collet torsional locking feature 22L or 24L expanding and binding in hole 4A, 4A-1, or 4A-2. Similarly, lower-collet relief 42L, allows the expansion of the lower collet 42 into the size or diameter of the hole, such as lower-plate hole 4A, 4A-1, or 4A-2, without having the lower-collet torsional locking feature 42L expanding and binding in hole 2A, 2A-1, or 2A-2. As such, in embodiments, the reliefs, for example, 22R (FIG. 12B), 23R (FIG. 12E), or 24R (FIG. 12H) and 42R (FIG. 13D) enable the expansion of the upper collet, such as upper collets 22, 23, or 24, independent of the expansion of the lower collet 42.

FIGS. 19A through 19C illustrate various views of expanding dowel pin 106, in addition to a bolt or machine screw 10, a washer 12, and a washer 13 (which has captive flats on its sides). FIG. 19A illustrates an exploded view of expanding dowel pin 106, including the orientation of its parts relative to each other. FIG. 19B illustrates an assembled dowel pin 106 with the bolt 10 passing through the washers 12 and 13, and then through the dowel pin 106. FIG. 19C illustrates a sectional view of dowel pin 106.

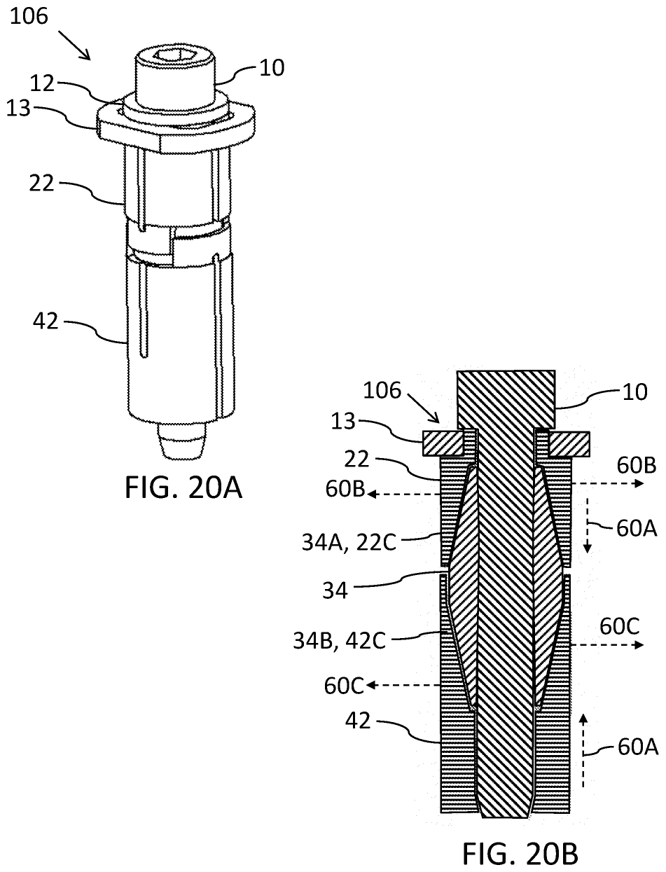

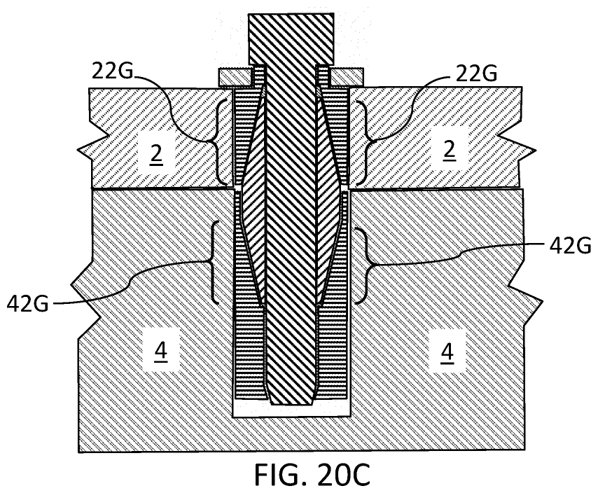

FIGS. 20A, 20B, and 20C further illustrate an expanding-dowel pin, such as expanding dowel pin 106, and how it may hold or fasten two plates, such as plates 2 and 4, together. In embodiments, the lower-collet internal screw threads 10A (shown in FIG. 19C) are configured to engage the bolt 10, such that, when the bolt 10 is rotated a first direction relative to the lower collet 42, the upper collet 22 and the lower collet 42 are configured to be compressed together by the bolt 10. In FIG. 20B, the bolt compressive force is labeled as 60A. The compressive bolt force 60A results in the first tapered cone 34A forcing the expansion of the upper-collet, inside-conical bore 22C, or the upper collet 22 and the second tapered cone 34B forcing the expansion of the lower-collet, inside-conical bore 42C, or the lower collet 42. In addition, the double-tapered cylinder 34 is configured such that compression 60A by the bolt 10 of the upper collet 22 towards the lower collet 42 does not deform the double-tapered cylinder 34 and the double-tapered cylinder 34 does not bind the bolt 10.

As an example application, the expansion of the upper collet 22 creates an upper-collet expansion force 60B, which presses the upper collet 22, at the upper-collet expansion surface 22G, against the sides of a hole formed in plate 2. Similarly, the expansion of the lower collet 42 creates a lower-collet expansion force 60C, which presses the lower collet 42, at the lower-collet expansion surface 42G, against the sides of a hole formed in plate 4. The expansion of the upper collet 22 may be independent of the expansion of the lower collet 42. Therefore, upper collet 22 may expand or be secured in a hole formed in plate 2 that is a different size than the hole formed in plate 4. Likewise, lower collet 42 may expand or be secured in a hole formed in plate 4 that is a different size than the hole formed in plate 2.

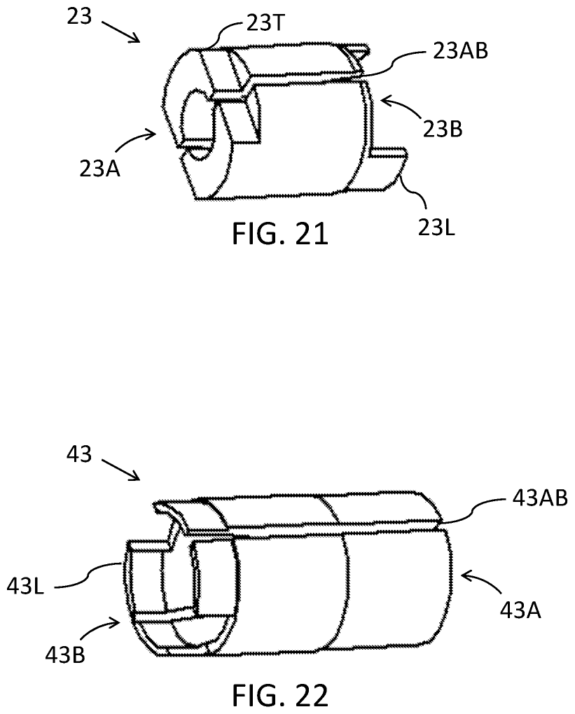

FIG. 21 illustrates an example upper collet 23 (also shown in FIGS. 12C, 12D, and 12E) with a single slit 23AB. Upper collet 23 has an upper-collet torsional locking feature 23L at its distal end 23B and upper-collet torsional captive flats 23T at its proximal end 23A. Similarly, FIG. 22 illustrates a lower collet 43 with a single slit 43AB, and lower-collet torsional locking feature 43L at its distal end 43B. Upper collet 23 and lower collet 43, with their single slits 23AB and 43AB, respectively, may be simpler to manufacture than other collets with multiple slits extending from different ends. However, the purpose of slits 23AB and 43AB is similar to that of other embodiments as the slits 23AB and 43AB enable the expansion of the collets, as described above, in other applications.

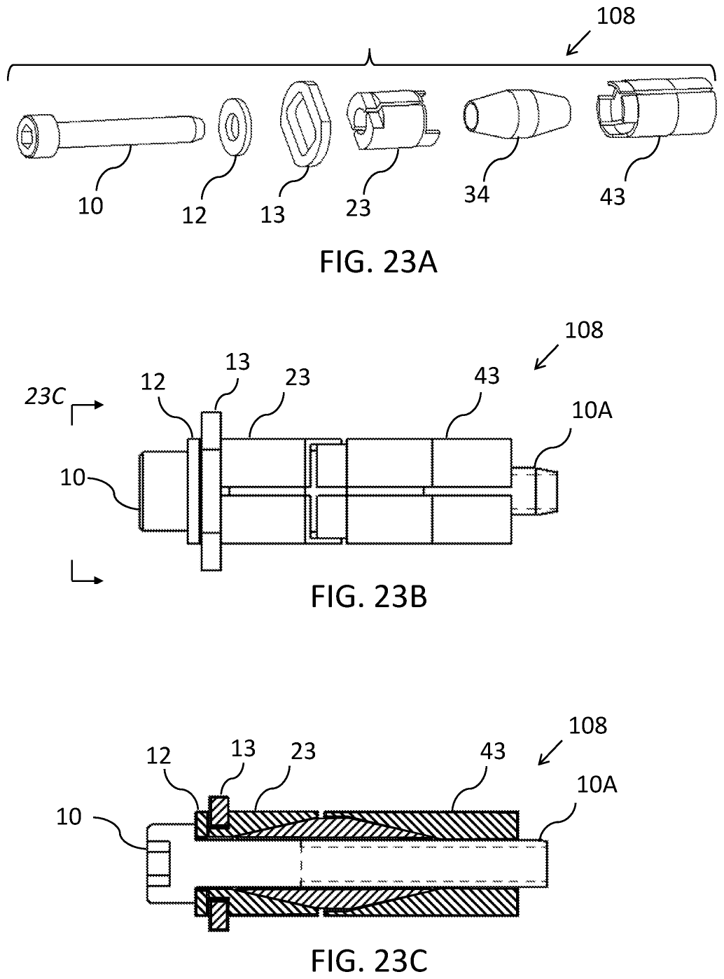

FIGS. 23A, 23B, and 23C illustrate different views of an example expanding dowel pin 108 that uses upper collet 23 and lower collet 43. Expanding dowel pin 108 is also illustrated as having doubled-tapered cylinder 34, however, double-tapered cylinder 30 might also be used in this embodiment.

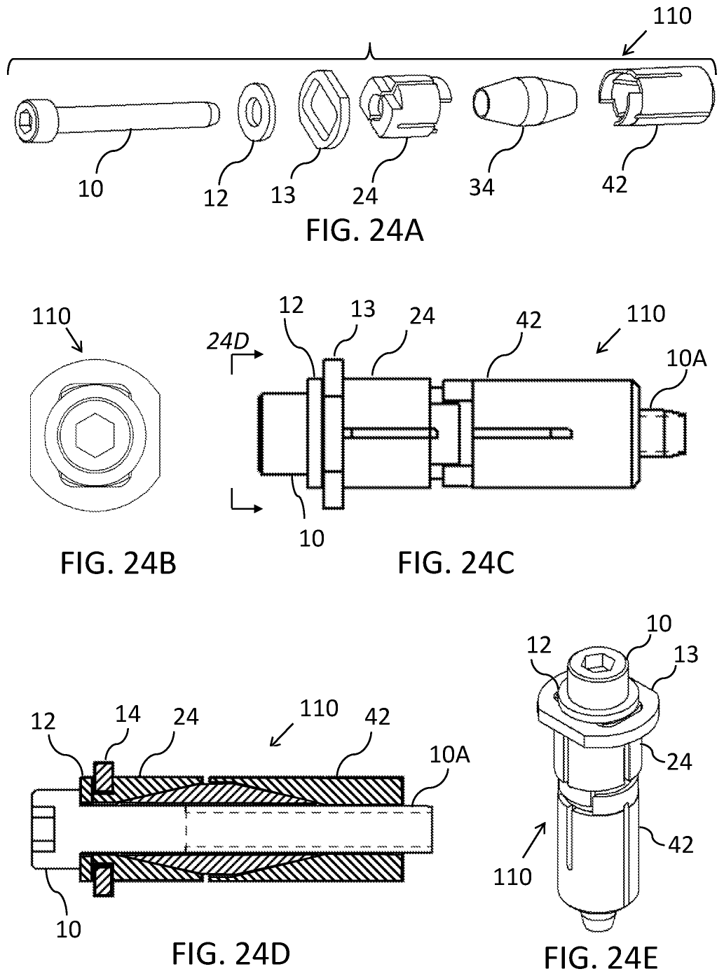

FIGS. 24A, 24B, 23C, and 24D illustrate different views of an example expanding dowel pin 110 that uses upper collet 24 and lower collet 42. Upper collet 24 is also illustrated in FIGS. 12F, 12G, and 12H. Upper collet 24 has an upper-collet flats 24S (shown in FIGS. 12F and 12G), located at radially opposite sides of the upper collet 24. The upper-collet flats 24S are also located 90-degree from the upper collet single slit 23AB. The upper-collet flats 24S are configured to interface with a rectangular-shaped slot instead of a round hole.

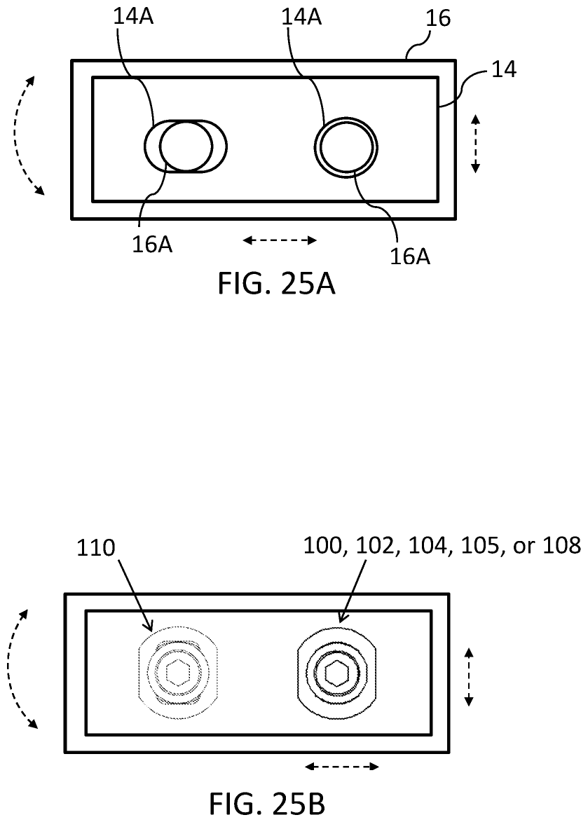

Referring to FIGS. 25A and 25B, expanding dowel pin 110 is configured to be placed into a slot formed within an upper plate 14, being an upper-plate slot 14A, then through a hole formed within a lower plate 16, being a lower-plate hole 16A. As described above, the upper-collet flats 24S are configured to interface with the upper-plate slot 14A. Further, in this embodiment, the upper-collet expansion force (similar to the upper-collet expansion force 20F shown in FIG. 7C) together with the lower-collet expansion force (similar to the lower-collet expansion force 40F shown in FIG. 7C) creates an expanding dowel pin alignment force that forces alignment between the upper-plate slot 14B and the lower-plate hole 16A. By way of illustration, in FIG. 25B, the expanding dowel pin assembly 100, 102, 104, 105, or 108 secures in two-degrees of freedom the upper plate 14 relative to the lower plate 16: up and down or vertically (as shown in the viewpoint of FIG. 25B) and left-to-right (also as shown in the viewpoint of FIG. 25B). However, the expanding dowel pin assembly 100, 102, 104, 105, or 108 does not secure the third-degree of freedom (rotation) as it does not prevent rotation of the upper plate 14 relative to the lower plate 16. For this, expanding dowel pin assembly 110 secures the third-degree of freedom by creating an expanding dowel pin alignment force that forces alignment between the upper-plate slot 14A and the lower-plate hole 16A.

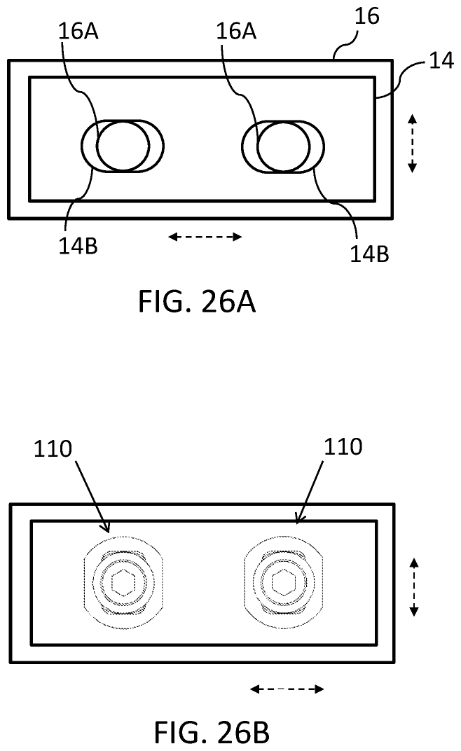

FIGS. 26A and 26B illustrate a further application of expanding dowel pin 110. In this illustration, upper plate 14 has two slots 14B that align with two holes 16A in lower plate 16. Inserting two dowel-pin assemblies 110 into the slots 14B and holes 16A secures plate 14 to plate 16 in two degrees-of-freedom: up and down or vertically and in rotation. The dowel-pin assemblies 110 do not constrain motion left-to-right, except for the friction force between the dowel-pin assemblies 110 and the sides of the slots 14B.

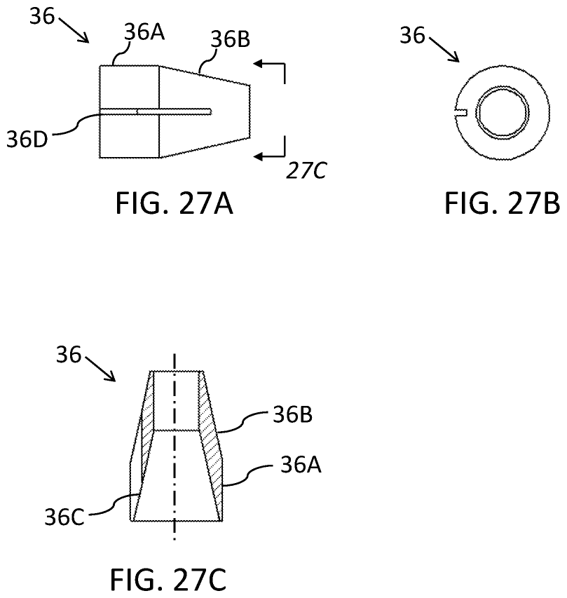

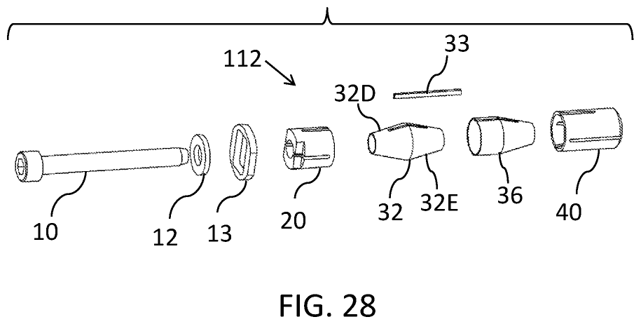

FIGS. 27A, 27B, and 27C illustrate different views of a chevron-shaped cylinder 36. FIG. 28 illustrates an exploded view of an expanded dowel pin 112 together with a bolt 10, washer 12, and washer 13. Chevron-shaped cylinder 36 may be used in or with an expanding dowel pin, e.g., expanding dowel pin 112 shown in FIG. 28. Chevron-shaped cylinder 36 includes a chevron, inside-conical bore 36A configured to interface with either the first tapered cone 32D or the second tapered cone 32E (both shown in FIG. 28, and similar to the first tapered cone 30D or the second tapered cone 30E shown in FIG. 5B). Chevron-shaped cylinder 36 is also configured to interface with either the upper-collet, inside-conical bore (e.g., 20C shown in FIG. 4C) or the lower-collet, inside conical bore (e.g., 40C, shown in FIG. 6C).

FIG. 28 illustrates an exploded view of expanding dowel pin 112. In this example, the upper collet 20, the double-tapered cylinder 32, the chevron-shaped cylinder 36, and the lower collet 40, are configured, in that order, to have a bolt 10 pass therethrough. Alternatively, the upper collet 20, the chevron-shaped cylinder 36, the double-tapered cylinder 32, and the lower collet 40, are configured, in that order, to have a bolt 10 pass therethrough. The chevron-shaped cylinder 36 may be placed on either side or on both sides of the double-tapered cylinder 32.

In this example, the chevron-shaped cylinder 36 enables broader application of the expanding dowel pin 112 to be used in different applications with different thickness plates, e.g., plates 2 and 4 (shown in FIGS. 1A through 2E). Chevron-shape cylinder 36 extends the length of other expanding dowel-pin assemblies. Further, the length of chevron-shape cylinder 36, or the cylinder portion 36A of chevron-shape cylinder 36, may be increased or decreased for specific applications or thicknesses of plates, e.g., plates 2 and 4.

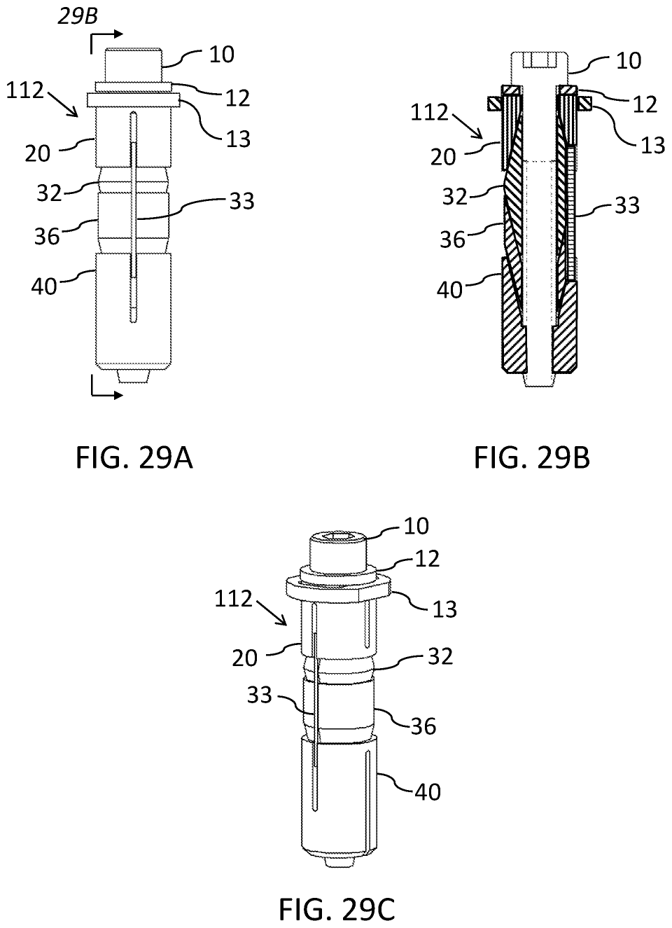

FIGS. 29A through 29C illustrated different views of an assembled expanding dowel pin 112. FIG. 29A is a side view, FIG. 29B is a cut-away view, and FIG. 29C. is an isometric view of expanding dowel pin 112. As in other embodiments of expanding dowel-pin assemblies, chevron-shape cylinder 36 maintains central alignment of the dowel pin 112 when the bolt 10 compresses the upper collet 20 towards the lower collet 40 around both the chevron-shaped cylinder 36 and the double-tapered cylinder 32. Also, in this embodiment, torsional locking key 33 may be included to extend from the upper collet 20 to the lower collet 40 and interface with both the upper collet 20 and the lower collet 40 such that a rotation of the upper collet 20 is locked relative to a rotation of the lower collet 40.

In another embodiment of the expanding dowel pin 112, when the bolt 10 is rotated the first direction relative to the lower collet 40, the upper collet 20 and the lower collet 40 are configured to be compressed together by the bolt 10, resulting in one of either: the first tapered cone 32D or the chevron-tapered cone 36B forcing the expansion of the upper-collet, inside-conical bore 20C, or, the second tapered cone 32E or the chevron-tapered cone 36B forcing the expansion of the lower-collet, inside-conical bore 40C.

In another embodiment of an expanding dowel pin assembly disclosed herein, the upper collet (e.g. 20, 21, 22, 23, or 24), the double-tapered cylinder (e.g., 30 or 32), and the lower collet (e.g., 40, 42, or 43) are configured such that when the bolt 10 is rotated opposite the first direction relative to the lower collet (e.g., 40, 42, or 43), the upper collet (e.g. 20, 21, 22, 23, or 24) moves away from the lower collet (e.g., 40, 42, or 43) creating a contraction of the upper-collet, inside-conical bore (e.g. 20C) and a contraction of the lower-collet, inside-conical bore (e.g., 40C).

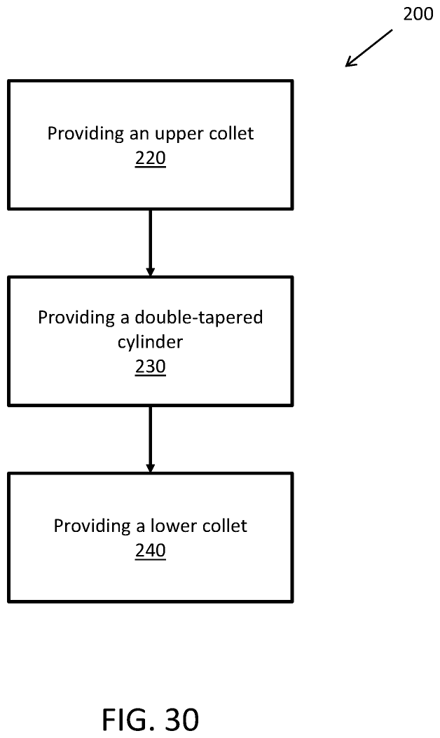

FIG. 30 illustrates a method 200 for providing an expanding dowel pin. The method comprises a step 220 of providing an upper collet, a step 230 of providing a double-tapered cylinder, and a step 240 of providing a lower collet. The upper collet may be any of the upper collets disclosed herein, e.g., upper collet 20, 21, 22, 23, or 24. The double-tapered cylinder may be any of the double-tapered cylinders disclosed herein, e.g., double-tapered cylinder 30, 32, or 34. The lower collet may be any of the lower collets disclosed herein, e.g., lower collet 40, 42, or 43. The various versions of embodiments of upper collets, double-tapered cylinders, and lower collets may be used or provided together to supply an expanding dowel pin.

The present invention may be embodied in other specific forms without departing from its spirit or essential characteristics. The described embodiments are to be considered in all respects only as illustrative, and not restrictive. All changes which come within the meaning and range of equivalency of the foregoing description are to be embraced within the scope of the invention.

It will be appreciated that several of the above-disclosed and other features and functions, or alternatives thereof, may be desirably combined into many other different systems or applications. Also, various presently unforeseen or unanticipated alternatives, modifications, variations or improvements therein may be subsequently made and are also intended to be encompassed by the following claims.

I claim:

1. An expanding dowel-pin, comprising:
an upper collet including:
an upper-collet proximal end and an upper-collet distal end; and
an upper-collet, inside-conical bore that is tapered more narrowly towards the upper-collet proximal end and having one or more upper-collet slits extending along a length of the upper-collet, inside-conical bore;
a double-tapered cylinder including:
a double-tapered cylinder first end, a double-tapered cylinder second end, and a double-tapered cylinder middle positioned between the double-tapered cylinder first end and the double-tapered cylinder second end; and
a first tapered cone tapering more narrowly from the double-tapered cylinder middle towards the double-tapered cylinder first end and a second tapered cone tapering more narrowly from the double-tapered cylinder middle to the double-tapered cylinder second end; and
a lower collet including:
a lower-collet proximal end and a lower-collet distal end;
a lower-collet, inside-conical bore that is tapered more narrowly towards the lower-collet proximal end and having one or more lower-collet slits extending along a length of the lower-collet, inside-conical bore; and
a lower-collet, inside-straight bore with lower-collet internal screw threads, the lower-collet, inside-straight bore extending from the lower-collet, inside-conical bore to the lower-collet proximal end;
wherein:
the upper collet, the double-tapered cylinder, and the lower collet are, in that order, configured to have a bolt pass therethrough;
the lower-collet internal screw threads are configured to engage the bolt, such that, when the bolt is rotated a first direction relative to the lower collet, the upper collet and the lower collet are configured to be compressed together by the bolt, resulting in the first tapered cone forcing the expansion of the upper-collet and the second tapered cone forcing the expansion of the lower-collet.

2. The expanding dowel-pin of claim 1, wherein:
the one or more upper-collet slits are four upper-collet slits: two, upper-collet, distal-end slits that extend from the upper-collet distal end and two upper-collet, proximal-end slits that extend from the upper-collet proximal end, each of the two upper-collet, distal-end slits are positioned 90-degrees radially of one of the two upper-collet, distal-end slits;
the one or more lower-collet slits are four lower-collet slits: two, lower-collet, distal-end slits that extend from the lower-collet distal end and two, lower-collet, proximal-end slits that extend from the lower-collet proximal end, each of the two, lower-collet distal-end slits are positioned 90-degrees radially of one of the two, lower-collet, distal-end slits;
the upper-collet, inside conical bore is configured to interface with the first tapered cone, making an upper-collet, double-tapered cylinder interface;
the lower-collet, inside conical bore is configured to interface with the second tapered cone, making a lower-collet, double-tapered cylinder interface;
the upper-collet, double-tapered cylinder interface and the four upper-collet slits are configured, in response to the bolt compressing the upper collet towards the lower collet, to create an upper-collet expansion force at the upper-collet, double-tapered cylinder interface;
the lower-collet, double-tapered cylinder interface and the four lower-collet slits are configured, in response to the bolt compressing the upper collet towards the lower collet, to create a lower-collet expansion force at the lower-collet, double-tapered cylinder interface; and
the upper-collet expansion force is independent of the lower-collet expansion force.

3. The expanding dowel-pin of claim 2, wherein:
the expanding dowel-pin is configured to be placed into a hole formed within an upper plate, being an upper-plate hole, then through another hole formed within a lower plate, being a lower-plate hole; and
the upper-collet expansion force together with the lower-collet expansion force creates an expanding dowel-pin concentric-alignment force that forces concentric alignment between the upper-plate hole and the lower-plate hole.

4. The expanding dowel-pin of claim 2, wherein:
the expanding dowel-pin is configured to be placed into a slot formed within an upper plate, being an upper-plate slot, then through a hole formed within a lower plate, being a lower-plate hole;
the upper collet further includes two upper-collet flats, each upper-collet flat located at a radially opposite side of the other upper-collet flat, the two upper-collet flats configured to interface with the upper-plate slot; and
the upper-collet expansion force together with the lower-collet expansion force creates an expanding dowel-pin alignment force that forces concentric alignment between the upper-plate slot and the lower-plate hole.

5. The expanding dowel-pin of claim 1, wherein the upper collet further includes upper-collet torsional captive flats, the upper collet configured to be held, by the upper-collet torsional captive flats, from rotating relative to the bolt when the bolt is rotated.

6. The expanding dowel-pin of claim 1, wherein:
the upper collet further comprises upper-collet torsional captive flats and an upper-collet torsional locking feature;
the lower collet further comprises a lower-collet torsional locking feature; and
when the bolt is rotated the first direction relative to the lower collet:
the upper-collet torsional captive flats are configured to be held from rotating relative to the bolt, and
the upper-collet torsional locking feature is configured to interface with and prevent rotation of the lower-collet torsional locking feature and rotation of the lower collet relative to the bolt.

7. The expanding dowel-pin of claim 1, further comprising a torsional locking key configured to extend from the upper collet to the lower collet and interface with both the upper collet and the lower collet such that a rotation of the upper collet is locked to a rotation of the lower collet.

8. The expanding dowel-pin of claim 1, wherein the double-tapered cylinder further comprises a straight cylinder positioned between the first tapered cone and the second tapered cone.

9. The expanding dowel-pin of claim 1, further comprising a chevron-shaped cylinder, the chevron-shaped cylinder having:
a chevron, inside-conical bore configured to interface with either the first tapered cone or the second tapered cone, and
a chevron-tapered cone configured to interface with either the upper-collet, inside-conical bore or the lower-collet, inside conical bore;
wherein, one of either:
the upper collet, the double-tapered cylinder, the chevron-shaped cylinder, and the lower collet, are configured, in that order, to have the bolt pass therethrough;
or,
the upper collet, the chevron-shaped cylinder, the double-tapered cylinder, and the lower collet, are configured, in that order, to have the bolt pass therethrough.

10. The expanding dowel-pin of claim 9, wherein:
when the bolt is rotated the first direction relative to the lower collet, the upper collet and the lower collet are configured to be compressed together by the bolt, resulting in one of either:
the first tapered cone or the chevron-tapered cone forcing the expansion of the upper collet,
or,
the second tapered cone or the chevron-tapered cone forcing the expansion of the lower collet.

11. The expanding dowel-pin of claim 1, wherein the first tapered cone is configured to make the expansion of the upper collet a uniform upper-collet expansion along the length of the upper collet, inside-conical bore and the second tapered cone is configured to make the expansion of the lower collet a uniform lower-collet expansion along the length of the lower-collet, inside-conical bore.

12. The expanding dowel-pin of claim 1, wherein the double-tapered cylinder is configured such that compression by the bolt of the upper collet towards the lower collet does not deform the double-tapered cylinder and the double-tapered cylinder does not bind the bolt.

13. A method of providing an expanding dowel-pin, the method comprising:
providing an upper collet, the upper collet including:
an upper-collet proximal end and an upper-collet distal end; and
an upper-collet, inside-conical bore that is tapered more narrowly towards the upper-collet proximal end and having one or more upper-collet slits extending along a length of the upper-collet, inside-conical bore; and
providing a double-tapered cylinder, the double-tapered cylinder including:
a double-tapered cylinder first end, a double-tapered cylinder second end, and a double-tapered cylinder middle positioned between the double-tapered cylinder first end and the double-tapered cylinder second end; and
the double-tapered cylinder having a first tapered cone tapering more narrowly from the double-tapered cylinder middle towards the double-tapered cylinder first end and a second tapered cone tapering more narrowly from the double-tapered cylinder middle to the double-tapered cylinder second end; and
providing a lower collet, the lower collet including:
a lower-collet proximal end and a lower-collet distal end;
a lower-collet, inside-conical bore that is tapered more narrowly towards the lower-collet proximal end and having one or more lower-collet slits extending along a length of the lower-collet, inside-conical bore; and
a lower-collet, inside-straight bore with lower-collet internal screw threads, the lower-collet, inside-straight bore extending from the lower-collet, inside-conical bore to the lower-collet proximal end;
wherein:
the upper collet, the double-tapered cylinder, and the lower collet, are configured, in that order, to have a bolt pass therethrough;
the lower-collet internal screw threads are configured to engage the bolt, such that, when the bolt is rotated a first direction relative to the lower collet, the upper collet and the lower collet are configured to be compressed together by the bolt, resulting in the first tapered cone forcing the expansion of the upper-collet, inside-conical bore and the second tapered cone forcing the expansion of the lower-collet, inside-conical bore.

14. The method of claim 13, wherein:
the one or more upper-collet slits are four upper-collet slits: two, upper-collet, distal-end slits that extend from the upper-collet distal end and two upper-collet, proximal-end slits that extend from the upper-collet proximal end, each of the two upper-collet, distal-end slits are positioned 90-degrees radially of one of the two upper-collet, distal-end slits;
the one or more lower-collet slits are four lower-collet slits: two, lower-collet, distal-end slits that extend from the lower-collet distal end and two, lower-collet, proximal-end slits that extend from the lower-collet proximal end, each of the two, lower-collet distal-end slits are positioned 90-degrees radially of one of the two, lower-collet, distal-end slits;
the upper-collet, inside conical bore is configured to interface with the first tapered cone, making an upper-collet, double-tapered cylinder interface;
the lower-collet, inside conical bore is configured to interface with the second tapered cone, making a lower-collet, double-tapered cylinder interface;
the upper-collet, double-tapered cylinder interface and the four upper-collet slits are configured, in response to the bolt compressing the upper collet towards the lower collet, to create an upper-collet expansion force at the upper-collet, double-tapered cylinder interface;
the lower-collet, double-tapered cylinder interface and the four lower-collet slits are configured, in response to the bolt compressing the upper collet towards the lower collet, to create a lower-collet expansion force at the lower-collet, double-tapered cylinder interface; and
the upper-collet expansion force is independent of the lower-collet expansion force.

15. The method of claim 13, wherein:
the upper collet further includes upper-collet torsional captive flats, the upper collet configured to be held, by the upper-collet torsional captive flats, from rotating relative to the bolt when the bolt is rotated the first direction relative to the lower collet.

16. The method of claim 13, wherein:
the upper collet further comprises upper-collet torsional captive flats and an upper-collet torsional locking feature;
the lower collet further comprises a lower-collet torsional locking feature; and
when the bolt is rotated the first direction relative to the lower collet:
the upper-collet torsional captive flats are configured to be held from rotating relative to the bolt, and
the upper-collet torsional locking feature is configured to interface with and prevent rotation of the lower-collet torsional locking feature and rotation of the lower collet relative to the bolt.

17. The method of claim 13, further comprising providing a torsional locking key, the torsional locking key configured to extend from the upper collet to the lower collet and interface with both the upper collet and the lower collet such that a rotation of the upper collet is locked to a rotation of the lower collet.

18. The method of claim 13, wherein the double-tapered cylinder further comprises a straight cylinder positioned between the first tapered cone and the second tapered cone.

19. The method of claim 13, further comprising providing a chevron-shaped cylinder, the chevron-shaped cylinder having:
a chevron, inside-conical bore configured to interface with either the first tapered cone or the second tapered cone, and
a chevron-tapered cone configured to interface with either the upper-collet, inside-conical bore or the lower-collet, inside conical bore;
wherein, one of either:
the upper collet, the double-tapered cylinder, the chevron-shaped cylinder, and the lower collet, are configured, in that order, to have the bolt pass therethrough;
or,
the upper collet, the chevron-shaped cylinder, the double-tapered cylinder, and the lower collet, are configured, in that order, to have the bolt pass therethrough.

20. An expanding dowel-pin, comprising:
an upper collet including:
an upper-collet proximal end and an upper-collet distal end;
an upper-collet torsional captive flats and an upper-collet torsional locking feature; and
an upper-collet, inside-conical bore that is tapered more narrowly towards the upper-collet proximal end; the upper-collet, inside-conical bore having one or more upper-collet slits extending along a length of the upper-collet, inside-conical bore;
a double-tapered cylinder including:
a double-tapered cylinder first end, a double-tapered cylinder second end, and a double-tapered cylinder middle positioned between the double-tapered cylinder first end and the double-tapered cylinder second end; and
the double-tapered cylinder having a first tapered cone tapering more narrowly from the double-tapered cylinder middle towards the double-tapered cylinder first end and a second tapered cone tapering more narrowly from the double-tapered cylinder middle to the double-tapered cylinder second end; and
a lower collet including:
a lower-collet proximal end and a lower-collet distal end;
a lower-collet torsional locking feature;
a lower-collet, inside-conical bore that is tapered more narrowly towards the lower-collet proximal end, the lower-collet, inside-conical bore having one or more lower-collet slits extending along a length of the lower-collet, inside-conical bore; and
a lower-collet, inside-straight bore with lower-collet internal screw threads, the lower-collet, inside-straight bore extending from the lower-collet, inside-conical bore to the lower-collet proximal end;
wherein:
the upper collet, the double-tapered cylinder, and the lower collet are, in that order, configured to have a bolt pass therethrough;
the lower-collet internal screw threads are configured to engage the bolt, such that, when the bolt is rotated a first direction relative to the lower collet, the upper collet and the lower collet are configured to be compressed together by the bolt, resulting in the first tapered cone forcing the uniform expansion of the upper-collet and the second tapered cone forcing the uniform expansion of the lower-collet, the uniform expansion of the upper-collet is independent of the uniform expansion of the lower-collet;
the upper-collet torsional captive flats are configured to be held from rotating relative to the bolt;
the upper-collet torsional locking feature is configured to interface with and prevent rotation of the lower-collet torsional locking feature and rotation of the lower collet relative to the bolt; and
the double-tapered cylinder is configured such that compression by the bolt of the upper collet towards the lower collet does not deform the double-tapered cylinder and the double-tapered cylinder does not bind the bolt.
